(19) United States
(12) Patent Application Publication
(10) Pub. No.: US 2019/0086950 A1
(43) Pub. Date: Mar. 21, 2019

(54) METHOD OF FLIPPING SCREEN IMAGE OF ELECTRONIC SCREEN

(71) Applicant: DATAVAN INTERNATIONAL CORP., New Taipei City (TW)

(72) Inventors: Chih-Hsiungmr CHEN, New Taipei (TW); Chun-Yi LEE, New Taipei (TW); Chih-Hung CHEN, New Taipei City (TW)

(21) Appl. No.: 15/710,182

(22) Filed: Sep. 20, 2017

(51) Int. Cl. G06F 1/16; G09G 5/38

(52) U.S. Cl. CPC G06F 1/1601; F16M 11/22; G09G 2340/0492; G09G 5/38

(57) ABSTRACT

The present disclosure illustrates a method of flipping screen image of an electric screen device. The electronic screen device is applicable to a POS system, and includes a mounting base member, a base, a rotation unit configured to movably assemble the mounting base member with the top of the base, and an electronic circuit system disposed inside the mounting base member. A built-in program of the electronic circuit system is activated to sense the electronic screen by a trigger manner or a time counting manner, and the built-in program receives a sensing signal from the sensor to determine whether the electronic screen is flipped, determining whether the window image shown on screen image of the electronic screen matches with a flip direction of the electronic screen, and if not, the window image shown on the display screen is flipped and the application program operated in the window image is activated.

### BACKGROUND OF THE INVENTION

### 1. Field of the Invention

The present disclosure generally relates to a method of flipping a screen image of an electronic screen. More particularly, the present disclosure relates to a method of determining whether the window image shown on the electronic screen is flipped along with flip operation of the electronic screen, and a device using the same. The electronic screen is flippably assembled on a base, and can be checked whether the window image shown on the electronic screen is flipped synchronously, so as to make the electronic screen and the window image are flipped in the same direction for users to watch easily.

### 2. Description of the Related Art

In a retail store, a supermarket or a hyper-supermarket, cash registers are disposed on checkout counters to record an amount of sold products and sales amount, and print invoices or receipts, and so on; however, user must manually check and calculate the import and export of products one by one, and the cash registers cannot process the management operation for import and export of products, so it is still inconvenient for the user in application of the cash register. In order to enable the retailer to manage and count the amount of the products when selling products, a company develops a Point Of Sales (POS) system which can count the amount of the sold products and sales amount, and manage import and export of products, display transaction details, and print invoices or receipts, so that the retailer can manage the products more easily and efficiently. As a result, more retailers apply the POS systems to improve performance of product sale and management.

The conventional POS system applicable to checkout operation is usually provided with a big screen for a store clerk to watch, and a small screen for a consumer to watch an amount of consumption, but the consumer cannot watch whole content of consumption. For this reason, a company develops a POS system provided with two big screens to display content of consumption for the store clerk and consumer to watch at the same time. Furthermore, a catering store provides a consumer to select and buy products through the electronic screen, and then perform checkout operation, thereby providing consumers more diverse product purchase ways. Above-mentioned POS system can be conveniently applied to meet the consumer's demand, but disposal of two screens also increases the price of the POS system, and some companies may not bear the POS systems with higher price. Furthermore, there are still some problems existing in actual application of the POS system having two big screens.

### SUMMARY OF THE INVENTION

An objective of the present disclosure is to provide an electronic screen device applicable to a PUS system. The electronic screen device includes a mounting base member disposed at a bottom thereof, and a base disposed correspondingly in position to the mounting base member, and a rotation unit configured to movably assemble the mounting base member with the top of the base, and an electronic circuit system disposed inside the mounting base member can activate an electronic screen and a build-in program. The built-in program of the electronic circuit system is activated to sense the electronic screen by a trigger manner or time counting manner, and the built-in program receives a sensing signal from the sensor which sense whether the electronic screen is flipped, and then determine whether the electronic screen is flipped, and then determine whether the window image shown on screen image of the electronic screen matches with a flip direction of the electronic screen, and if not, the window image is flipped and an application program corresponding to the window image is activated, whereby the purpose of automatically flipping the window image of the display screen of the electronic screen device can be achieved.

Another objective of the present disclosure is that in the electronic screen device, a display screen is disposed in a screen case of the electronic screen to display the window image, and an electronic circuit system is disposed in a mounting base member at a bottom of the screen case, and configured to store and execute a built-in program; a base is disposed correspondingly in position to a bottom of the mounting base member, and a butt joint part is disposed on a top of the base, two stop parts are respectively disposed on two opposite sides of the butt joint part, a sensor is disposed near to a side of the butt joint part to sense a rotational direction of the mounting base member of the electronic screen; and the mounting base member of the electronic screen and the butt joint part on the top of the base are movably and pivotally assembled with each other through a shaft and an axle hole of the rotation unit, so that the electronic screen can be flipped around the top of the base by an appropriate angle.

Another objective of the present disclosure is that the electronic screen is a touch screen applicable to a POS system to display a product catalogue for selection and checkout; the electronic screen includes an electronic circuit system disposed inside the mounting base member, and the electronic circuit system includes a preset circuit layout, and a processing unit for storing and executing programs, and the processing unit is electrically coupled to the sensor to sense the rotational direction of the mounting base member; and the processing unit is configured to store and execute the built-in program for operation of the electronic screen, activating an application program for flip operation of the window image. Preferably, the electronic screen can be a LCD screen with touch function, a LED display screen with touch function, a touch screen of a smartphone, or a touch screen of a tablet computer.

### BRIEF DESCRIPTION OF THE DRAWINGS

FIG. 1 is an exploded view of an electronic screen device with a flippable electronic screen, in accordance with the present disclosure.

FIG. 2 is a side view of the electronic screen device of the present disclosure, before the electronic screen is flipped.

FIG. 3 is a side view of the electronic screen device of the present disclosure, while the electronic screen is being flipped.

FIG. 4 is a side view of the electronic screen device of the present disclosure, after the electronic screen is flipped.

FIG. 5 is a flowchart showing the steps in a first part of an operation of a method of flipping the electronic screen, in accordance with the present disclosure.

FIG. 6 is a flowchart showing the steps in a second part of an operation of a method of flipping the electronic screen, in accordance with the present disclosure.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These tennis are used only for the purpose of distinguishing one component from another component. Thus, a first element discussed herein could be termed a second element without altering the description of the present invention. As used herein, the terra “or” includes any and all combinations of one or more of the associated listed items.

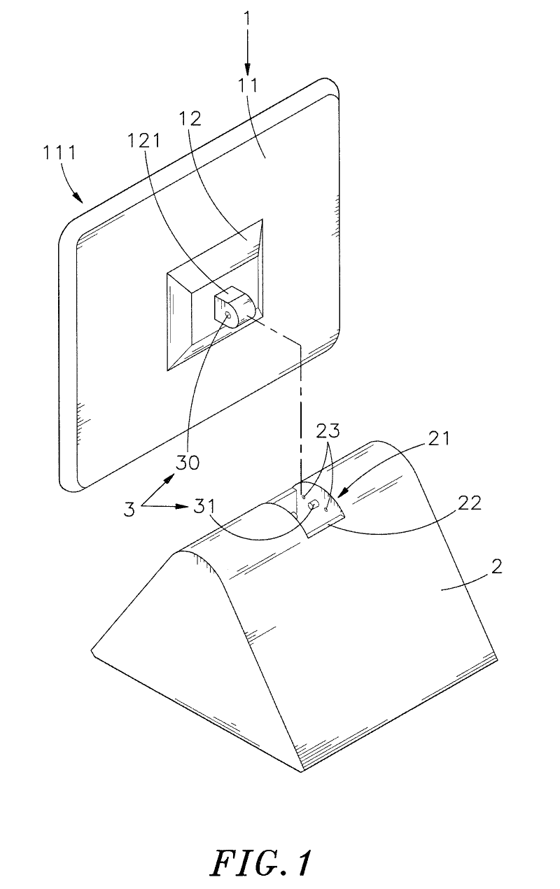

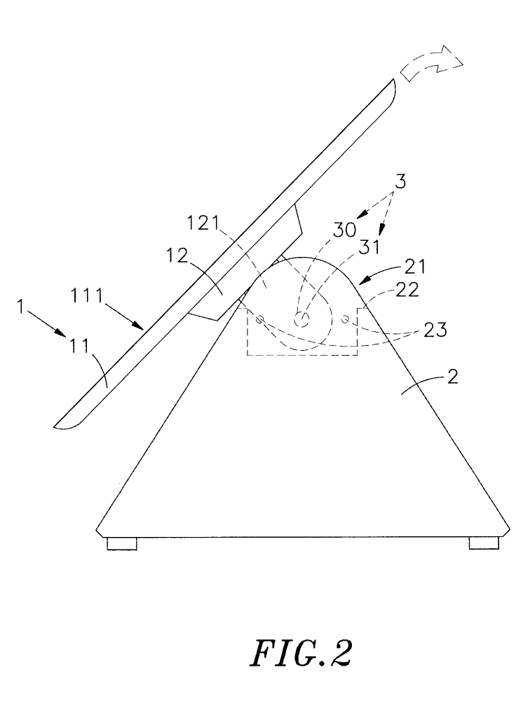

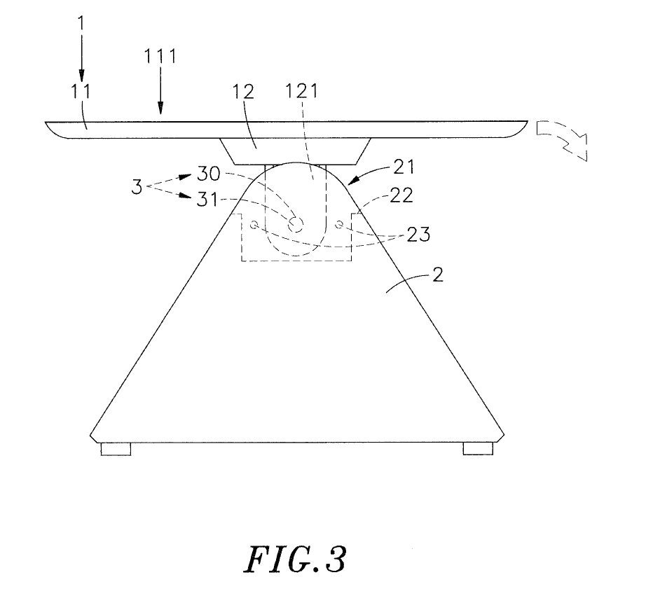

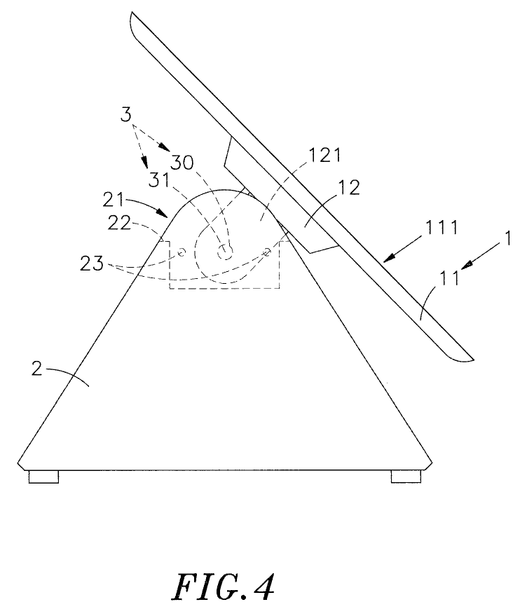

Please refer to FIGS. 1 through 4. An electronic screen device of the present disclosure includes an electronic screen 1, a base 2 and a rotation unit 3.

The electronic screen 1 is applicable to a Point Of Sales (POS) system, and includes a screen case 11, a mounting base member 12 disposed at a bottom of the screen case 11. The screen case 11 includes a display screen 111 disposed on an outer surface of the screen case 11, and an electronic circuit system having a preset circuit layout is disposed inside the mounting base member 12. The electronic circuit system is installed with driver programs, application programs and so on. The mounting base member 12 includes a connection member 121 disposed at a bottom thereof.

The base 2 includes a butt joint part 21 disposed at a top thereof, and stop parts 22 respectively disposed at two opposite sides of the butt joint part 21, and a sensor 23 disposed on a side surface of the butt joint part 21.

The rotation unit 3 includes a shaft 31 and an axle hole 30 which are pivotally connected to each other.

In order to assemble aforementioned members, the mounting base member 12 on the bottom of the screen case 11 of the electronic screen 1 is aligned with the butt joint part 21 on the top of the base 2, and the connection member 121 on the bottom of the mounting base member 12 is assembled with the butt joint part 21 by pivotally connecting the axle hole 30 and the shaft 31 of the rotation unit 3, and the sensor 23 of the base 2 is electrically coupled to the electronic circuit system disposed inside the mounting base member 12, so that the electronic screen 1 can be assembled with the butt joint part 21 on the top of the base 2, and the electronic screen 1 and the mounting base member 12 are rotatable around the butt joint part 21 of the base 2 by an appropriate angle. As a result, the electronic screen 1, the base 2 and the rotation unit 3 can be assembled as the electronic screen device of the present disclosure.

The electronic screen 1 is movably assembled on the top of the base 2, and the mounting base member 12 at the bottom of the electronic screen 1 can be rotated around the butt joint part 21 at the top of the base 2 through the rotation unit 3. When the mounting base member 12 of the screen case 11 is abutted against the stop part 22 at a side of the butt joint part 21, the display screen 111 on the outer surface of the screen case 11 can display a window image associated with the application program which may be an application program of the POS system. When the screen case 11 and the mounting base member 12 are flipped towards other side of the butt joint part 21, the sensor 23 at the side surface of the butt joint part 21 may sense the rotation direction of the mounting base member 12 and then transmit the sensing signal to the electronic circuit system inside the mounting base member 12. Next, when the mounting base member 12 is rotated to abut with the other stop part 22 of the butt joint part 21 and the built-in program of the electronic circuit inside the mounting base member 12 receives the sensing signal from the sensor 23, the window image of the display screen 111 of the screen case 11 is flipped by the built-in program along with flipping operation of the screen case 11, so that the store clerk and the consumer can watch window image at different side sequentially.

Preferable, the electronic screen 1 can be a touch screen applicable to the POS system which displays a product catalogue for a consumer to click and checkout. The electronic screen 1 includes an electronic circuit system disposed inside the mounting base member 12 at the bottom of the screen case 11. The electronic circuit system includes a preset circuit layout, and a processing unit for storing and executing program. The processing unit of the electronic circuit system is electrically coupled to the sensor 23, and after the sensor 23 senses a rotation direction of the mounting base member 12 rotating around the butt joint part 21, the sensor 23 transmits a sensing signal to the processing unit, and the processing unit can execute the built-in program to control operation of the electronic screen 1, flip the window image, and start the application program, and so on. Preferably, the electronic screen 1 can be a touch screen with a liquid crystal display screen, a LED display screen, and so on.

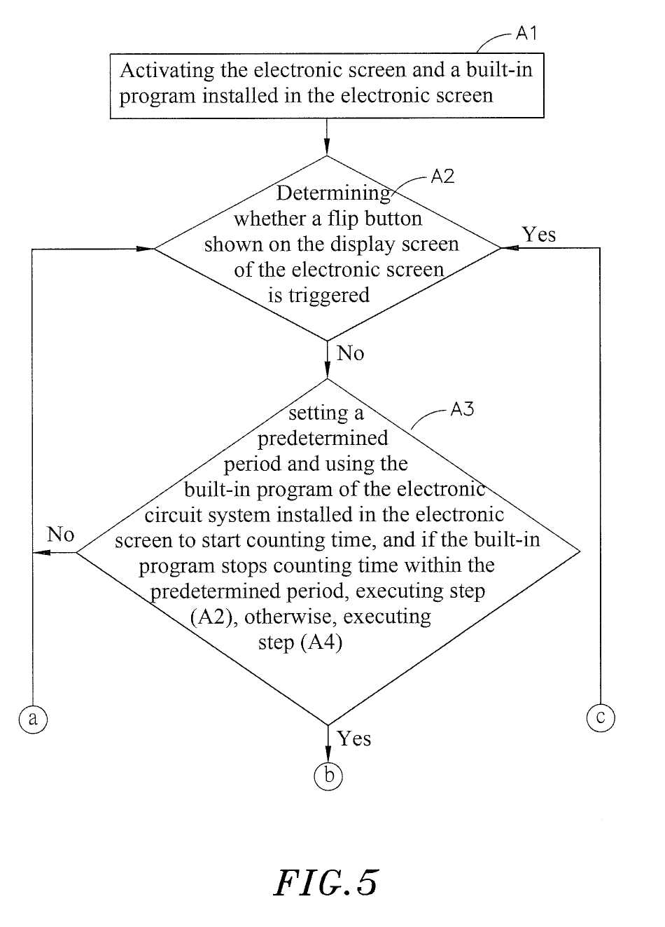

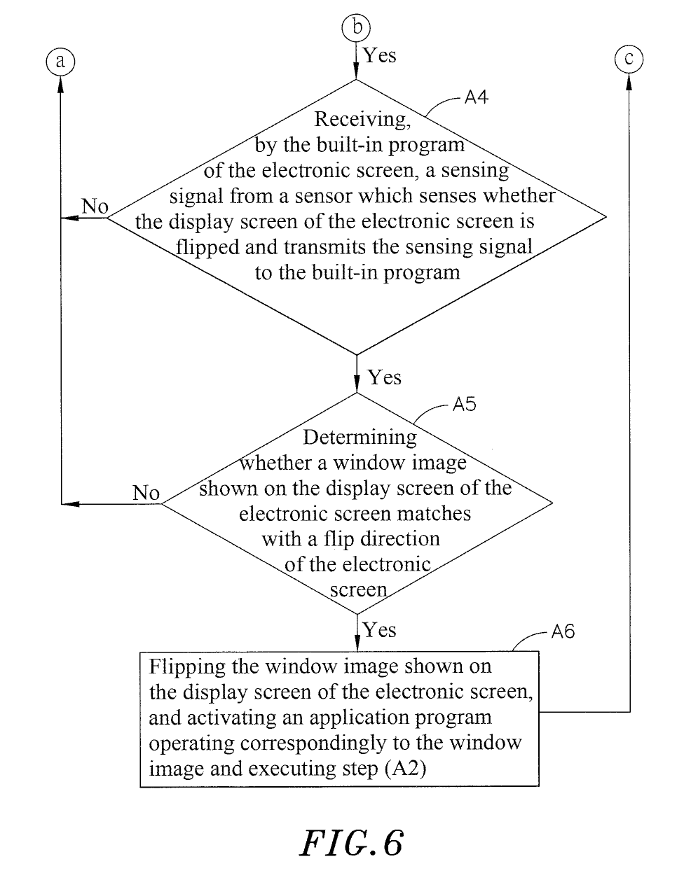

Please refer to FIGS. 1, 2, 5 and 6. The electronic screen device of the present disclosure includes the electronic screen 1, the base 2 and the rotation unit 3. The electronic screen 1 is applicable to the POS system. The electronic screen 1 includes the screen case 11 with the display screen 111, and the mounting base member 12 disposed at the bottom of the screen case 11. The base 2 is disposed correspondingly in position to the mounting base member 12, and the rotation unit 3 is disposed between the mounting base member 12 and the top of the base 2. The following describes steps of an operation of the method of flipping screen.

In a step A1, the electronic screen 1, and the built-in program stored in the electronic circuit system inside the mounting base member 12 are activated respectively.

In a step A2, it is determined whether a flip button of the window image shown on the display screen 111 of the screen case 11 of the electronic screen 1 is triggered. If not, a step A3 is executed; otherwise, if yes, a step A6 is executed.

In the step A3, a predetermined counting period is set, the built-in program of the electronic circuit system inside the mounting base member 12 of the electronic screen 1 starts counting time, and when the built-in program keeps counting in whole predetermined period, a step A4 is executed; when the built-in program stops counting within the predetermined period, the step A2 is executed.

In the step A4, the built-in program of the electronic circuit system inside the mounting base member 12 of the electronic screen 1 receives the sensing signal from the sensor 23 and determines whether the display screen 111 of the electronic screen 1 is flipped according to the sensing signal. If yes, a step A5 is executed; If not, the step A2 is executed.

In the step A5, it is determined whether the window image on the display screen 111 of the electronic screen 1 matches with a flip direction of the electronic screen 1. If not, a step A6 is executed; and if yes, the step A2 is executed.

In a step A6, the electronic circuit system inside the mounting base member 12 controls the driver program to flip the window image shown on the display screen 111 of the electronic screen 1, and runs the application program operated in the window image. Next, the step A2 is executed.

In the electronic screen 1, a electronic circuit system is disposed inside the mounting base member 12 at the bottom of the screen case 11, and the electronic circuit system includes the preset circuit layout, and the processing unit for storing and executing programs. The processing unit of the electronic circuit system is electrically coupled to the sensor 23, so that the sensor 23 can sense the rotation direction of the mounting base member 12 relative to the butt joint part 21 and then transmit the sense signal to the processing unit. The processing unit is configured to store and execute the built-in program to control the operation of the electronic screen 1, the application program for flipping the window image, and so on. The electronic screen 1 can be flipped between the left and right sides of the base 2 by an appropriate angle, such as 135 degrees, 150 degrees or another angle. Furthermore, the window image shown on the display screen 111 on the outer surface of the screen case 11 can also be flipped by the appropriate angle along with the flipping operation of the electronic screen 1, so that users at left and right sides of the base 2 can watch the window image shown the display screen 111 sequentially. In an embodiment, the window image can be an image for paying bills, or an image of a product catalogue, a dining menu, menu, price details, or the application program applied in the POS system.

The electronic screen 1 is applicable to the POS system, and the electronic screen 1 thereof can be flipped leftwardly or rightwardly around the base 2, so that the operator and the consumer can sequentially watch the window image shown on the display screen 111. As a result, it is not necessary to dispose two electronic screens 1 on the POS system, thereby reducing cost and obtaining higher economic benefits of the POS system.

The present disclosure disclosed herein has been described by means of specific embodiments. However, numerous modifications, variations and enhancements can be made thereto by those skilled in the art without departing from the spirit and scope of the invention set forth in the claims.

What is claimed is:

1. A method of flipping a screen image of an electronic screen device which comprises an electronic screen, a base, and a rotation unit to pivotally connect the electronic screen with the base, wherein the electronic screen is applicable to a POS system and comprises a screen case with a display screen to show the screen image, the screen case comprises a mounting base member disposed at a bottom of the screen case, and the mounting base member disposed correspondingly in position to the base, and the rotation unit is disposed between the mounting base member and a top of the base, and the method comprises steps of:
(A1) activating the electronic screen and a built-in program installed in the electronic screen;
(A2) determining whether a flip button shown on the display screen of the electronic screen is triggered; if not, executing step (A3), and if yes, executing step (A6);
(A3) setting a predetermined period and using the built-in program installed in the electronic screen to start counting time, and if the built-in program stops counting time within the predetermined period, executing step (A2), otherwise, executing step (A4);
(A4) receiving, by the built-in program of the electronic screen, a sensing signal from a sensor which senses whether the display screen of the electronic screen is flipped, and transmits the sensing signal to the built-in program, and when the sensing signal indicates that the display screen is flipped, executing step (A5), otherwise, executing step (A2);
(A5) determining whether a window image shown on the display screen of the electronic screen matches with a flip direction of the electronic screen, and if not, executing step (A6), otherwise, executing step (A2); and
(A6) flipping the window image shown on the display screen of the electronic screen, and activating an application program operating correspondingly to the window image, and executing step (A2).

2. The method according to claim 1, wherein the electronic screen in step (A1) is a touch screen, and the electronic screen comprises the mounting base member disposed at the bottom thereof, and the mounting base member corresponds in position to the base, and the rotation unit is configured to pivotally connect the bottom of the mounting base member with the top of the base, so that the electronic screen and the mounting base member is flippable around the top of the base through the rotation unit by a predetermined angle, and the base further comprises a sensor disposed at the top thereof and configured to sense whether the mounting base member of the electronic screen is rotated, as indicated in step (A4).

3. The method according to claim 2, wherein the electronic screen is a liquid crystal display screen with touch function, a LED display screen with touch function, a touch screen of a smartphone, or a touch screen of a tablet computer.

4. The method according to claim 2, wherein the electronic screen comprises an electronic circuit system disposed inside the mounting base member and comprising a preset circuit layout and an application program, and the rotation unit is configured to pivotally connect the bottom of the mounting base member with the top of the base, and the rotation unit comprises a shaft and an axle hole respectively disposed on the mounting base member and the top of the base.

5. The method according to claim 1, wherein the electronic screen comprises the mounting base member disposed on the bottom thereof, and the mounting base member comprises an electronic circuit system storing the built-in program, and the electronic circuit system comprises a processing unit configured to store and execute the built-in program, and the processing unit executes the flipping operation of the screen image when the flip button is manually triggered in step (A2) or the built-in program starts counting time in step (A3).
